(19) United States
(12) Patent Application Publication
(10) Pub. No.: US 2023/0284333 A1
(43) Pub. Date: Sep. 7, 2023

(54) CONTROL OF COMMUNICATION DEVICES IN A WIRELESS NETWORK

(71) Applicant: Charter Communications Operating, LLC, St. Louis, MO (US)

(72) Inventors: Umamaheswar A. Kakinada, Greenwood Village, CO (US); Hossam H. Hmimy, Aurora, CO (US); Muhammad J. Khan, Greenwood, CO (US)

(21) Appl. No.: 17/684,595

(22) Filed: Mar. 2, 2022

(51) Int. Cl. H04W 76/30; H04W 76/10; H04W 48/02; H04W 68/00; H04W 52/02

(52) U.S. Cl. CPC H04W 76/30; H04W 76/10; H04W 48/02; H04W 68/00; H04W 52/0261; H04L 67/12

(57) ABSTRACT

A communication management resource manages wireless connectivity of multiple wireless communication devices including a first wireless communication device to a wireless network. The communication management resource detects a condition in which to terminate wireless access services provided to the first wireless communication device via the wireless network. In response to the detected condition, the communication management resource communicates with the first wireless communication device to terminate use of the wireless access services by the first wireless communication device. This disclosure further includes device pollution prevention techniques leveraging standard messages or a new message. For example, this disclosure includes: i) a low impact, non-physical termination of a wireless communication device, ii) backward compatible techniques to decommission legacy devices, iii) leveraging of existing messages and framework in wireless specifications to support this enhancement, iv) addressing the problem of wireless pollution without physically sending someone to de-activate the device.

### BACKGROUND

One type of wireless network supporting connectivity of devices to a remote server is known as LoRaWAN™. In general, LoRa™ (short for long range) is a spread spectrum modulation technique derived from Chirp Spread Spectrum (CSS) technology, providing wireless connectivity of devices to the Internet and managing communications between end-node devices and network gateways.

Such a network architecture deploys a so-called star-of-stars topology in which gateways relay messages between end-devices and a central network server. The gateways are connected to the network server via standard IP connections and act as a transparent bridge. The bridges serve to convert RF packets to IP packets and vice versa depending on a direction of the communications. During operation, the wireless communication supports connectivity at the physical layer such as a single-hop link between the end-device and one or more gateways.

### BRIEF DESCRIPTION OF EMBODIMENTS

Embodiments herein provide improved implementation of wireless access networks and expand use of limited wireless bandwidth in a network environment.

More specifically, a communication management resource manages wireless connectivity of multiple wireless communication devices, including at least a first wireless communication device, to a wireless network. The communication management resource detects a condition in which to terminate wireless access services provided to the first wireless communication device via the wireless network. In response to the detected condition, the communication management resource communicates with the first wireless communication device to terminate the wireless access services providing the first wireless communication device connectivity to the wireless network.

In yet further example embodiments, the communication management resource receives notification of a request by the first wireless communication device to establish a wireless communication link with the wireless network. The communication management resource maps an identity of the first wireless communication device to termination information specifying to terminate the wireless access services. In one embodiment, the communication management resource communicates a command to the first wireless communication device. Execution of the command by the first wireless communication device prevents the first wireless communication device from attempting to wirelessly communicate with the wireless network again.

In still further embodiments herein, the communication management resource responds to the first wireless communication device with a join accept message. For example, the communication management resource communicates a join accept message to the first wireless communication device. The join accept message normally grants a wireless connection of the first wireless communication device to the wireless network. In one embodiment, the join accept message further includes a command notifying the first wireless communication device that the available wireless access services have been revoked. Execution of the command by the first wireless communication device prevents subsequent connectivity of the first wireless communication device with the wireless network.

Still further example embodiments herein include, via the communication management resource, transmitting a communication to the first wireless communication device. The communication includes a command to operate the first wireless communication device in a mode of depleting an energy source powering the first wireless communication device. The command can be configured to indicate any suitable information. In one embodiment, the command indicates to operate the first wireless communication device in a transmitter mode of transmitting wireless signals such as at a specified time to deplete the energy source.

The wireless access services provided to the first wireless communication device can be terminated in any suitable manner. For example, in one embodiment, the communication management resource transmits a command notifying the first wireless communication device to deplete an energy source powering the first wireless communication device such as via transmission of wireless signals from the first wireless communication device. In one embodiment, the command specifies settings in which to transmit the wireless signals from the first wireless communication device.

In yet further example embodiments, the communication management resource receives a request from the first wireless communication device to use the wireless access services. In response to receiving a request to use the wireless access services, the communication management resource detects that an identity of the wireless communication device is on a termination list and communicates a denial of service notification to the first wireless communication device. The denial of service notification denies use of the wireless access services by the first wireless communication device.

Yet further embodiments herein include, via the communication management resource, transmitting reconfiguration information to the first wireless communication device. Execution of the reconfiguration information by the first wireless communication device prevents the wireless communication device from communicating with the wireless network using the wireless access services. In further example embodiments, the communication management resource notifies the wireless communication device of a scheduled time in which to receive the reconfiguration information. The communication management resource or other suitable entity broadcasts the reconfiguration information to the first wireless communication device and at least one other wireless communication device at the scheduled time.

In still further example embodiments, the first wireless communication device is configured to support deactivation of itself based on receipt of a command. For example, the configuration management hardware as discussed herein can be configured to terminate use of the wireless access services by the first wireless communication device via communication of a command to the communication device; the command causes the first wireless communication device to deactivate (i.e., kill) itself and discontinue any further operations including attempted connectivity with the wireless network.

In accordance with another embodiment herein, the communication management resource as discussed herein notifies the first wireless communication device of a scheduled time in which to receive a software patch for execution by the first wireless communication device. The communication management resource or other suitable entity transmits the software patch to the first wireless communication device and potentially other communication devices as well at the scheduled time. Execution of the patch by the one or more communication devices causes the respective one or more communication devices to deactivate themselves and discontinue any further operations including attempted connectivity with the wireless network.

Embodiments herein are useful over conventional techniques. For example, implementation of a communication management resource and corresponding operations as discussed herein provide one or more ways to control (such as prevent) connectivity of wireless communication devices to a wireless network. The decommissioning one or more of the wireless communication devices reduces unwanted wireless interference otherwise caused by those devices.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by the computer processor hardware, cause the computer processor hardware (such as one or more co-located or disparately processor devices or hardware) to: manage wireless connectivity of multiple wireless communication devices to a wireless network, the multiple wireless communication devices including a first wireless communication device; detect a condition in which to terminate wireless access services provided to the first wireless communication device via the wireless network; and in response to the detected condition, communicate with the first wireless communication device to terminate use of the wireless access services by the first wireless communication device.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a network environment supporting termination of wireless access according to embodiments herein.

FIG. 2 is an example diagram illustrating communication flow supporting termination of wireless access according to embodiments herein.

FIG. 3 is an example diagram illustrating operations associated with terminating one or more communication devices according to embodiments herein

FIG. 4 is an example diagram illustrating depletion of stored energy in a communication device according to embodiments herein.

FIG. 5 is an example diagram illustrating denial of service according to embodiments herein.

FIG. 6 is an example diagram illustrating generation of a termination list and denial of service in response to a rejoin request according to embodiments herein.

FIG. 7 is an example diagram illustrating notification of a scheduled broadcast to a group of one or more communication devices according to embodiments herein.

FIG. 8 is an example diagram illustrating broadcast of configuration settings at a scheduled time to terminate operation of one or more communication devices according to embodiments herein.

FIG. 9 is an example diagram illustrating generation of channel allocation information indicating allocation of bandwidth at different tiers of a channel hierarchy according to embodiments herein.

FIG. 10 is an example diagram illustrating example computer hardware and software operable to execute operations according to embodiments herein.

FIG. 11 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DESCRIPTION OF EMBODIMENTS

Wireless communication devices such as IoT (Internet of Things) devices are inexpensive and ubiquitous. While implementation of such devices has many advantages, their presence can potentially cause unwanted wireless interference when they are no longer needed to perform a respective function. Many unused wireless communication devices violate wireless regulatory rules, resulting in issues such as duty cycle violations.

In addition to wireless interference, the unwanted wireless communication devices create unwanted backhaul traffic, affecting a respective hardwired backhaul network. In such an instance, a great deal of processing power is wasted in processing data from the undesirable wireless devices. Once deployed, it is difficult and expensive to remove or deactivate many IoT devices. This renders it difficult and inefficient to identify and troubleshoot problem devices. Currently, the LoRa Specs do not define any procedure or mechanism for decommissioning devices in a desirable manner.

To mitigate unwanted and/or unnecessary wireless interference caused by wireless communication devices, embodiments herein include a communication management resource that manages wireless connectivity of multiple wireless communication devices including a first wireless communication device to a wireless network. The communication management resource detects a condition in which to terminate wireless access services provided to the first wireless communication device via the wireless connectivity. In response to the detected condition, the communication management resource communicates with the first wireless communication device to terminate the wireless access services providing the first wireless communication device the wireless connectivity to the wireless network.

More specifically, as discussed herein, embodiments herein include a multipronged solution to address decommissioning of one or more wireless communication devices. For example, in one embodiment, the communication management resource as discussed herein addresses such issues by learning device profile information and using a combination of one or more of the following techniques.

In one embodiment, the communication management resource as discussed herein terminates legacy devices by instructing them to cease execution of one or more functions. After the target device being terminated determines the authenticity of a respective communication management resource, the source implements instructions such as JoinReq->JoinAns->JoinAccept.

Many or (most) wireless communication devices are battery powered. One embodiment herein includes triggering depletion energy stored in the battery using one or more of the following techniques: i) the target device can be configured to transfer a huge amount of data to a targeted list of devices, such as through multicast/broadcast/FUOTA (such as Firmware update over the air)/etc. communications to make it effective at a time convenient for the operator to deplete the battery on device, ii) LoRaWAN allows end-devices to use any of the possible data rates and transmit (TX) power individually. This feature is used by Network Servers to adapt and optimize the number of retransmissions, the data rate, and the TX power of end-devices (such as devices implementing LoRa Spec LoRaWAN L2 v 1.0.4). iii) provide the targeted set of devices with modified channel map and power level trigger repeated reties on device to deplete battery and cause the device to die (low data rate, High Tx power, at wrong channel)

Further embodiments herein include updating the device image with right credentials so as to enable pass authentication of the wireless communication device but nullify the device functionality. In such an instance, the device ceases to function normally after software update. This can be done with FUOTA for a targeted set of selected devices

Trigger re-authentication on the device and make authentication to fail in the join server for the targeted set of devices

In one embodiment, a novel join response message indicates a new bit attribute, notifying the wireless communication device not to attempt any further connections with the network and/or to cease all functions. This join response as a result of authentication prevents malicious attempts by non-authorized entities to decommission the wireless communication device. In one embodiment, all message exchanges associated with the procedure of terminating functionality and decommissioning a respective device are secure.

Further embodiments herein include creating a RED-list (termination list) of devices in the system which need to be retired from service, and propagate it to all functional components in the network (LoRa-GW, NS, JS and AS), preventing device access at different network layers

Thus, embodiments herein include: i) a low impact, non-physical manner in which to terminate operation of a wireless communication device, ii) backward compatible techniques to decommission legacy devices, iii) leveraging of existing messages and framework in LoRa or other wireless specifications to support this enhancement, iv) addressing the problem of device pollution without physically sending someone on site to de-activate the device (which is typically expensive).

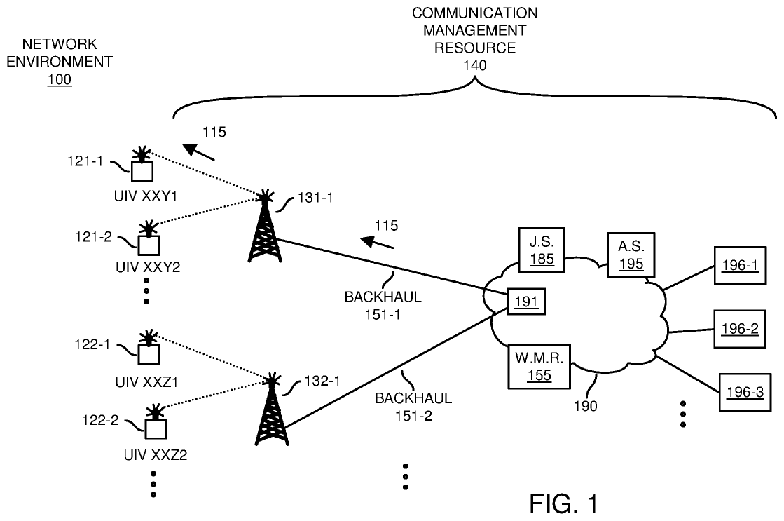

FIG. 1 is an example diagram illustrating implementation of a communication management resource according to embodiments herein.

Embodiments herein include network environment 100 and components including communication management resource 140 providing wireless access management to one or more communication devices 121-1, 121-2, . . . , 122-1, 122-2, etc.

As further shown, the network environment 100 includes gateway 131-1 (such as a wireless base station or wireless access point) providing a first set of communication devices 121 including communication device 121-1, communication device 121-2, etc. Network environment 100 further includes gateway 132-1 (such as a wireless base station or wireless access point) providing a second set of communication devices 122 including communication device 122-1, communication device 122-2, etc.

Each of the communication devices can be configured to perform any suitable one or more functions. For example, in one embodiment, each of the communication device can be configured to be (an Internet of things) type of device such as a physical object or device embedded with one or more of sensors, processing ability, software, and other technologies that connect and exchange data with other devices and systems over the Internet or other communications networks.

Authentication server further examples, each of the wireless communication devices can be configured to implement one or more monitoring functions associated with appliances, smart home security systems, autonomous farming equipment, wearable health monitors, smart factory equipment, vending machines, wireless inventory trackers, ultra-high speed wireless internet, water meter monitors, biometric cybersecurity scanners, etc.

Initially, for security reasons, each of the communication devices in network environment 100 communicates with one or more servers (such as join server, authentication server, etc.) in the network environment 100 to establish connectivity with a respective one or more application server 196.

For example, in one nonlimiting example embodiment, assume that the communication device 121-1 would like to communicate with a respective application server 196-1 such as because the communication device 121-1 has collected data and needs to forward the data to the application server 196-1. In such an instance, the communication device 121-1 communicates a join request message to the gateway 131-1, which forwards the join request message over backhaul 151-1 to network server 191. Network server 191 forwards the join request to the join server 185. The join server 185 initiates authentication of the communication device 121-1 to use the wireless connectivity provided by the gateway 131-1 via one or more communications to the authentication server 195.

Note that the authentication can be based on a unique identifier value assigned to the communication device 121-1 such as XXY1 (i.e., a unique identifier value assigned to the communication device 121-1) as well as any other information (such as credentials including one or more of a password, key, access information, etc.) provided by the communication device to the join server 185. In one embodiment, the join server 185 forwards any suitable information associated with the communication device 121-1 to the authentication server 195. As its name suggests, the authentication server 195 authenticates the communication device based on the received information.

Subsequent to authentication of the respective communication device 121-1, the join server 185 communicates a so-called join answer to the network server 191. For example, the network server 191 further communicates a respective join accept or join reject message to the communication device 121-1 depending upon whether or not the communication device 121-1 passes authentication. If the communication device 121-1 is authenticated for use, the combination of the gateway 131-1 and the network 190 provide connectivity of the communication device 121-1 to the application server 196-1.

For example, after authentication, the communication device 121-1 can be configured to upload respective data to the application server 196-1 over a communication path including the wireless connection between the communication device 121-1 and the gateway 131-1, backhaul 151-1, and connectivity through the network server 191 to the application server 196-1. In a reverse direction, the application server 196-1 can be configured to communicate one or more commands or data to the communication device 121-1 over the communication path.

Note that the communication management resource (i.e., communication management resource 140) associated with or disposed in one or more of the join server 185, gateway 131, gateway 132, authentication server 195, etc., as described herein can be implemented in any suitable manner. For example, the communication management resource 140 can be implemented as communication management hardware, communication management software, or a combination of communication management hardware and communication management software. The join server 185 can be implemented as join server hardware, join server software, or a combination of join server hardware and join server software. The gateway 131 can be configured as gateway hardware, gateway software, or a combination of gateway hardware and gateway software. The authentication server 195 can be implemented as authentication server hardware, authentication server software, or a combination of authentication server hardware and authentication server software.

In further example embodiments, the communication management resource 140 (a.k.a., configuration management resource) manages wireless connectivity of multiple wireless communication devices 121, 122, etc., including wireless communication device 121-1 provided wireless access to application servers 196 via respective wireless services. In one embodiment, assume that the communication management resource 140 detects a condition in which to terminate wireless access services provided to the wireless communication device 121-1 via the wireless network supported by gateway 131-1. In response to the detected condition, in one or more different ways as described herein, the communication management resource 140 communicates with the wireless communication device 121-1 (such as via communications 115) to terminate the wireless access services providing the wireless communication device 121-1 connectivity to the wireless network associated with gateways 131, 132, etc., and network 190.

In a similar manner, the one or more entities associated with the communication management resource 140 can be configured to manage wireless connectivity associated with multiple wireless communication devices.

Note that the network environment 100 can be configured to further include wireless access manager 155. The wireless access manager 155 allocates one or more wireless channels associated with a wireless spectrum for use by a respective one or more resources in the network environment 100. In one non-limiting example embodiment, the wireless access manager 155 allocates one or more channels from a CBRS (Citizen Band Radio System) spectrum.

In still further example embodiments, note that each of the one or more communication devices 121-1, 121-2, . . . 122-1, 122-2, etc., can be configured to support a termination command causing the corresponding wireless communication device to terminate further functionality. For example, in one embodiment, any of one or more entities associated with communication management resource 140 can be configured to communicate (such as via communications 115) a respective termination command to a respective wireless communication device. If so configured, the wireless communication device receiving and executing the command causes the corresponding wireless communication device executing the command to terminate use of the wireless access services. In such an instance, the communication management resource 140 controls connectivity of the respective wireless communication device via communications of a command that causes the respective wireless communication device to deactivate (kill) itself from further communications with the wireless network.

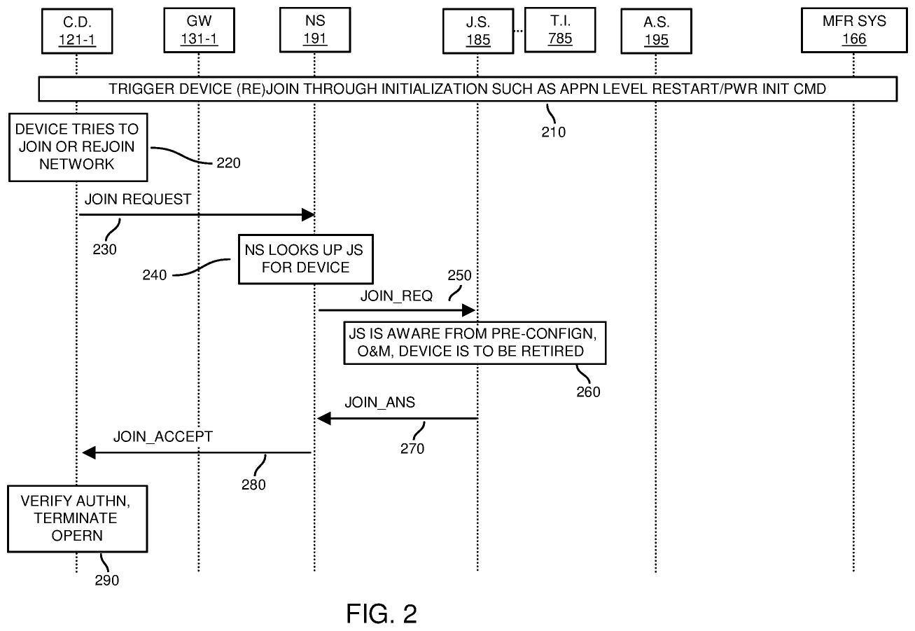

FIG. 2 is an example diagram illustrating communication flow supporting termination of wireless access according to embodiments herein.

In this example embodiment, in operation 210, manufacturing systems 166 trigger devices to rejoin through initialization such as application level restart/power initialization commands.

For example, in processing operation 220, assume that the communication device 121-1 decides to join or rejoin the respective network 190. To this end, the communication device 121-1 communicates a respective join request in wireless communications 230 over a respective path between communication device 121-1 through gateway 131-1 and backhaul 151-1 to the network server 191. In one embodiment, the communication device 121-1 generates the join request in order to establish a respective connectivity with network 190 and possibly one or more of the application servers 196. The communication device 121-1 can be configured to generate the request in response any condition such as because the communication device 121-1 has data to communicate to the application server 196-1.

Thus, via communications 230, the network server 191 associated with the communication management resource 140 receives notification (such as including unique identifier value XXY1) of a request by the first wireless communication device 121-1 to establish a wireless communication link with the wireless network and network 190.

As further shown, in processing operation 240, the network server 191 looks up a respective join server to service the received requests. The network server 191 maps an identity (such as unique identifier value XXY1) assigned to and received in communications 230 from the first wireless communication device to the join server 185. Via the communications 250, the network server 191 forwards the join request associated with the communication device 121-1 to the join server 185.

The join server 185 accesses termination information 785 to determine if the communication device 121-1 is allowed to use the respective network 190 to communicate with a desired one or more of application servers 196. In this example embodiment assume that the termination information 785 indicates to terminate (such as retire) the wireless communication device 121-1 such that the communication device 121-1 is no longer provided wireless access to any gateways or network 190 or application servers 196 in the network environment 100.

In response to mapping the identity (unique identifier value XXY1) of the wireless communication device 121-1 to corresponding information in termination information 785 indicating to terminate use of the wireless communication device 121-1, the network server 191 associated with the communication management resource 140 communicates join answer in communications 270 to the network server 191. In one embodiment, the communications 270 indicate to provide the wireless communication device 121-1 wireless connectivity to the gateway 131-1 and corresponding network 190. However, the communications 270 further include a command notifying the network server 191 to decommission the wireless communication device 121-1.

As further shown, via communications 280, the network server 191 associated with the communication management resource 140 responds to prior communications 230 from the first wireless communication device 121-1 with a join accept message. For example, the communication management resource 140 communicates a join accept message from network server 140 through gateway 131-1 to the first wireless communication device 121-1. In one embodiment, the join accept message grants or at least indicates that a wireless connection has been granted to the first wireless communication device to access the wireless network via gateway 131-1 and corresponding network 190.

In one embodiment, the join accept message and corresponding communications 280 include a command notifying the first wireless communication device that the wireless access services have been revoked. Thus, even though the response to the communication device 121-1 is a join accept message, the communication device 121-1 receives notification in the communications 282 to terminate further attempts to connect to the network 190 via one or more gateway. In other words, execution of the command by the first wireless communication device 121-1 prevents subsequent connectivity of the first wireless communication device 121-1 with the wireless network including gateways, backhauls, network server, join server, as shown, network 190, etc.

In one embodiment, execution of the command received by the wireless communication device 121-1 via communications 280 prevents the first wireless communication device 121-1 from attempting to wirelessly communicate with the wireless network and corresponding resources (such as gateways 131, 132, etc.) again on subsequent occasions.

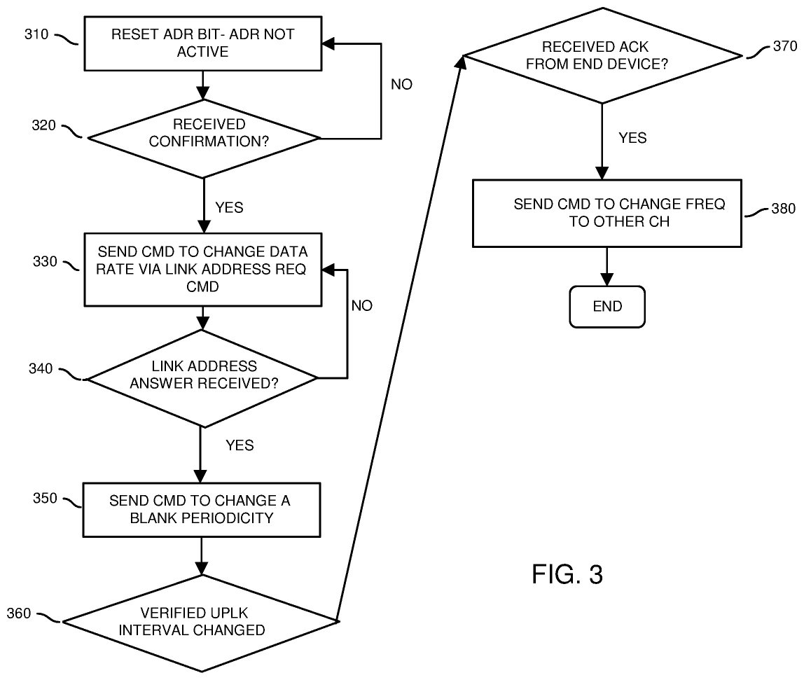

FIG. 3 is an example diagram illustrating operations associated with terminating one or more communication devices according to embodiments herein.

In processing operation 310, the communication management resource 140 resets a respective ADR (Adaptive Data Rate) bit associated with the wireless communication device 121-1 such that the ADR mode is not active at the wireless communication device 121-1. For example, the network server 191 of the communication management resource 140 communicates the reset command (reset of ADR bit) over backhaul 151-1 through gateway 131-1 over a respective wireless communication link to the wireless communication device 121-1.

In processing operation 320, the communication management resource 140 determines whether or not the wireless communication device 121-1 confirms receipt of the reset command. If not, process flow continues again at processing operation 310 in which the network server 191 tries again to reset the ADR bit associated with the wireless communication device 121-1. Alternatively, in response to detecting that the wireless communication device 121-1 received and executed the communicated command resetting the ADR bit, processing continues at processing operation 330.

In processing operation 330, the communication management resource sends a command to change the data rate of the wireless communication device 131-1 via a link address request command communicated from the network server 191 over backhaul 151-1 through the gateway 131-1 to the wireless communication device 121-1. In one embodiment, the link address request command changes a respective data rate to DR0 (such as a lowest or lower data rate). As a response to receiving the command, the wireless communication device 121-1 transmits further communications at the low bit rate as requested by the change data rate.

In processing operation 340, the communication management resource 140 determines whether or not the wireless communication device 121-1 confirms receipt of the link address request command via receipt of a link address answer from the wireless communication device 121-1. If not, process flow continues again at processing operation 330 in which the network server 191 tries again to communicate the link at request command to the wireless communication device 121-1. Alternatively, in response to detecting that the wireless communication device 121-1 received and executed the link address request command, processing continues at processing operation 350.

In processing operation 350, the communication management resource 140 sends a command to change a blank periodicity of the wireless communication device 131-1 via a respective command communicated from the network server 191 over backhaul 151-1 through the gateway 131-1 to the wireless communication device 121-1. In one embodiment, the command changes a rate at which the wireless communication device 121-1 transmits respective wireless signals in the network environment 100. In one embodiment, the command causes the wireless communication device to wirelessly transmit signals in a high rate to deplete a respective battery resource used to power the wireless communication device 121-1. As a response to receiving the command, the wireless communication device 121-1 transmits further communications (wireless signals) at a higher rate (such as every 10 seconds or other suitable value) as specified by the received command.

In processing operation 360, the communication management resource 140 verifies that the wireless communication device 121-1 has updated the interval of transmitting wireless communications in the network environment 100.

In subsequent processing operation 370, the communication management resource 140 monitors to determine if the wireless communication device 121-1 sends an appropriate acknowledgment to the network server 190 indicating the change in data rate of transmitting wireless communications in the network environment 100. If so, processing continues at processing operation 380.

In processing operation 380, the network server 191 of the communication management resource 140 notifies (via communications through backhaul 151-1 and gateway 131-1) the wireless communication device 121-1 to transmit at a selected wireless channel CHX other than the initial wireless channel (such as wireless channel CH1) used by the wireless communication device 121-1 or other wireless communication devices to transmit communications. The notification to switchover communications to wireless channel CHx reduces interference on wireless channel CH1.

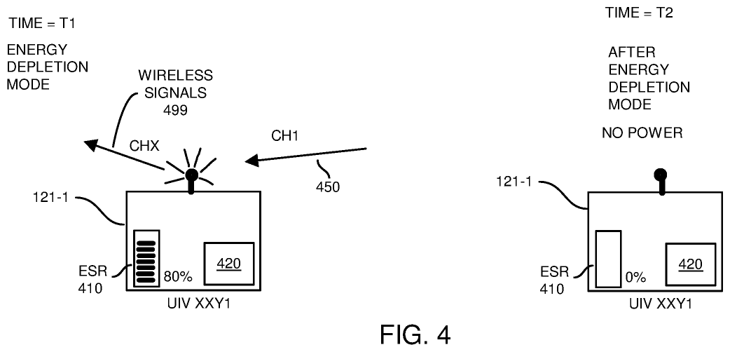

FIG. 4 illustrates an example of decommissioning a respective wireless communication device based on the communication flow discussed in FIG. 3.

For example, the wireless communication device 121-1 initially operates in a normal mode of connecting to the network 190 in a manner as previously discussed. The communication management resource 140 transmits a communication 450 to the first wireless communication device 121-1. The communications 450 include a command to operate the first wireless communication device 121-1 in a mode of depleting an energy storage resource 410 (a.k.a., energy source) powering respective electronics and the first wireless communication device 121-1 at or around time T1. The command received from the communication management resource 140 can be configured to indicate any suitable information. In one embodiment, the command indicates to operate the first wireless communication device 121-1 in a transmitter mode of transmitting wireless signals at a specified time or range at time deplete the energy storage resource 410 such that the wireless communication device 121-1 is unable to further communicate with any of the gateways or network 190.

In one embodiment, the communications 450 further include information indicating a respective wireless channel CHx in which the wireless communication device 121-1 is to transmit the wireless signals 499 in order to deplete the energy stored in energy storage resource 110.

At or around time or time duration T1, the repeated transmission of the wireless signals 499 eventually causes the complete depletion of energy stored in the energy storage resource 110 at or around time=T2 such that the wireless communication device 121-1 is no longer able to access the wireless network or transmit any further wireless signals 499 because it has no power. In such an instance, the wireless communication device 121-1 is terminated from accessing the network.

Accordingly, the wireless access services initially provided or made available to the first wireless communication device 121-1 can be terminated. For example, in one embodiment, the communication management resource 140 transmits a command in communications 450 notifying the first wireless communication device to deplete an energy source powering the first wireless communication device via transmission of wireless signals 499 from the first wireless communication device 121-1. The command specifies any suitable information. For example one embodiment, the command (such as in communications 450) specifies settings (such as wireless channel, duration of time, repeat time interval, wireless transmit power level, etc.) in which the wireless communication device 121-1 is to transmit the wireless signals 499 from the first wireless communication device. In one embodiment, the communications 450 (such as via a channel request MAC command communicated from the network server 190 to the wireless communication device 121-1) notify the wireless communication device 121-1 to transmit wireless signals 499 in a respective channel (such as wireless channel CHx) that does not interfere with other communications between the other wireless communication devices in the network 190 and gateway 131-1.

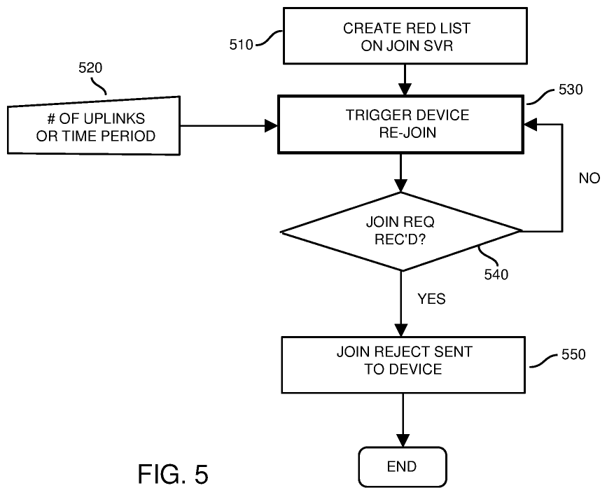

FIG. 5 is an example diagram illustrating denial of wireless service and wireless connectivity according to embodiments herein.

In this example embodiment, in processing operation 510, the communication management resource 140 creates a respective red list (also known as a termination list 785) indicating identities of the one or more wireless communication devices that are being terminated from using further wireless services in the network environment 100 to access the network 190 and corresponding components.

In processing operation 530, the communication management resource 140 triggers a respective device rejoin via communication of a respective command to the terminated wireless communication device 121-1. In one embodiment, in furtherance of triggering the rejoin, the communication management resource 140 receives communication information such as number of uplinks or communication time period information associated with the one or more wireless communication devices that are in the termination list.

In processing operation 540, the communication management resource 140 determines whether or not the wireless communication device 121-1 acknowledges receipt of the re-join request command via the network server 191 receiving a re-join request communicated from the wireless communication device 121-1 through the gateway 131-1 to the network server 191. If not, process flow continues again at processing operation 530 in which the network server 191 tries again to communicate the re-join request command to the wireless communication device 121-1. Alternatively, in response to detecting that the network server 191 received the re-join request command from the wireless communication device 121-1, processing continues at processing operation 550.

In processing operation 550, in response to the network server 191 of the communication management resource 140 receiving the triggered rejoin request from the wireless communication device 121-1, in accordance with the termination list indicating that the wireless communication device 121-1 is to be terminated from using wireless services associated with the wireless network 190, the network server 191 communicates a respective join reject communication to the wireless communication device 121-1. This notifies the wireless communication device 121-1 that it is not allowed to use wireless services through the gateway 131-1 to access the network 190.

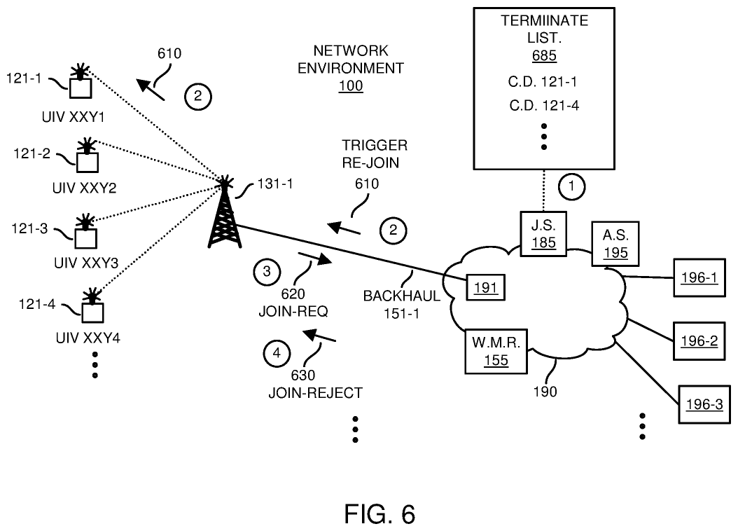

FIG. 6 is an example diagram illustrating generation of a termination list and denial of service in response to a rejoined request according to embodiments herein.

In yet further example embodiments, the communication management resource 140 can be configured to generate or receive a termination list 785 indicating one or more communication devices not to provide wireless connectivity to the gateway and/or network 190. For example, in processing operation #1, the join server 185 receives or generates the termination list 785 indicating to deny wireless connectivity to communication device 121-1, communication device 121-4, etc.

In response to receiving the re-join notification communication 610, the wireless communication device 121-1 communicates a respective join request via communications 620 in processing operation #3 through the gateway 131-1 to the network server 191. Thus, via communications 620 in processing operation #3, the communication management resource 140 receives a re-join request from the first wireless communication device 121-1 to use wireless access services associated with the wireless network supported by gateway 131-1.

In response to receiving the re-join request in communications 620 to use the wireless access services provided by the gateway 131-1 and corresponding wireless network, via communications 630 in processing operation #4, the communication management resource 140 communicates a denial of service notification (such as join-reject communication) over backhaul 151-1 through the gateway 131-1 to the first wireless communication device 121-1. The denial of service notification as indicated by the communications 630 deny wireless communication device 121-1 use of the wireless access services associated with the wireless network of gateway 131-1.

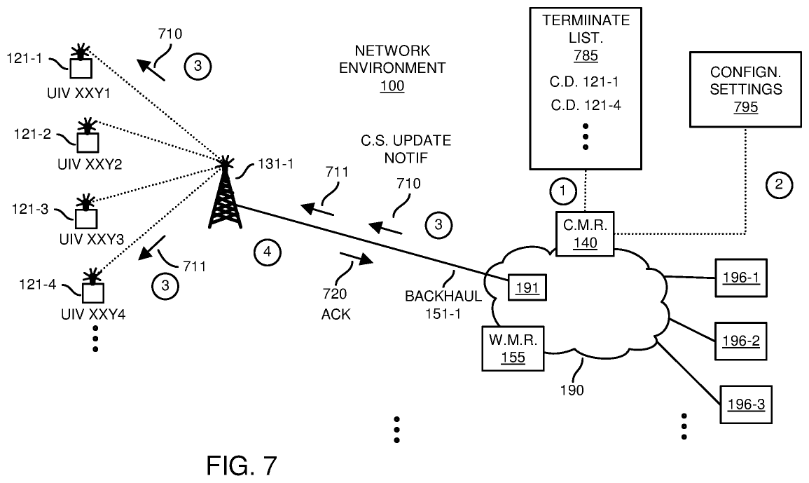

FIG. 7 is an example diagram illustrating notification of a scheduled broadcast to a group of one or more communication devices according to embodiments herein.

In this example embodiment, the communication management resource 140 is configured to generate or receive a termination list 785 indicating one or more communication devices not to provide wireless connectivity to the gateway and/or network 190. For example, in processing operation #1, the join server 185 of communication management resource 140 receives or generates the termination list 785 indicating to terminate wireless services available to communication device 121-1, communication device 121-4, etc., to access the network 190.

As further shown FIG. 7, in order to terminate wireless network access ability, the communication management resource 140 or other suitable entity generates configuration settings 795 for installing on each of the communication devices in the termination list 785.

In one embodiment, the configuration settings 795 are to be executed (i.e., implemented) by each of the communication devices on the termination list 785. The configuration settings 795 can be any suitable information implemented by the communication devices such as executable code, data, instructions, commands, one or more software patches, etc., that disables the respective communication device from attempting to communicate with the gateways again.

In further example embodiments, while the wireless communication device 121-1 is in communication with network 190 and one or more corresponding communication resources in network 190, the communication management resource 140 as discussed herein notifies, such as via communications 710, the wireless communication device 121-1 in the termination list 785 of the need to update respective configuration settings associated with the wireless communication device 121-1 via configuration settings 795.

Note that the communications 710 can include additional information supporting retrieval or receipt of the configuration settings 795 by the respective wireless communication device in the list 785 at an appropriate time. For example, in one embodiment, the communications 710 include a scheduled time (such as 1:00 am on Feb. 20, 2022 when the wireless usage is low and such multicast link will cause minimal interference) in which the wireless communication device 121-1 is to join a multicast group and retrieve/receive the configuration settings 795 (reconfiguration information preventing the corresponding wireless communication device from using wireless network services) transmitted (such as broadcast) from the gateway 131-1 or other suitable entity to one or more wireless communication devices.

Note that the communications 710 can include further information associated with the broadcast of the configuration settings 795 such as encryption information required to decrypt the configuration settings 795 broadcasted during a communication session in which the wireless communication device 121-1 receives the configuration settings 795 transmitted at 1 am from the wireless station 131-1 on Feb. 20, 2022.

In further example embodiments, while the wireless communication device 121-4 is in communication with network 190 and one or more corresponding communication resources in network 190, the communication management resource 140 as discussed herein notifies, such as via communications 711, the wireless communication device 121-4 in the termination list 785 of the need to update its configuration settings associated with the wireless communication device 121-4.

Note that the communications 711 can include additional information supporting retrieval or receipt of the configuration 795 by the respective wireless communication device in the list 785 at an appropriate time. For example, in one embodiment in a similar manner as previously discussed, the communications 711 include a scheduled time (such as 1:00 am on Feb. 20, 2022) in which the wireless communication device 121-4 is to join a multicast group and retrieve/receive the configuration settings 795 (reconfiguration information preventing the corresponding wireless communication device from using wireless network services) transmitted (such as broadcast) from the gateway 131-1 or other suitable entity to one or more wireless communication devices. Note that the communications 711 can include further information associated with the broadcast of the configuration settings 795 such as encryption information required to decrypt the configuration settings 795 during a multicast communication session in which the wireless communication device 121-4 receives the figuration settings 795 transmitted at 1 am over a respective multicast link from the wireless station 131-1 (or other gateway) on Feb. 20, 2022.

Thus, the same configuration settings 795 can be used to update operation of multiple wireless communication devices via a single broadcast from one or more of the gateways 131.

As further discussed below, each of the wireless communication devices 121-1 and 121-4 connect with the communication management resource 140 at or around 1:00 am on Feb. 20, 2022) when the communication management resource 140 or other suitable entity broadcasts the 795 to the wireless communication devices.

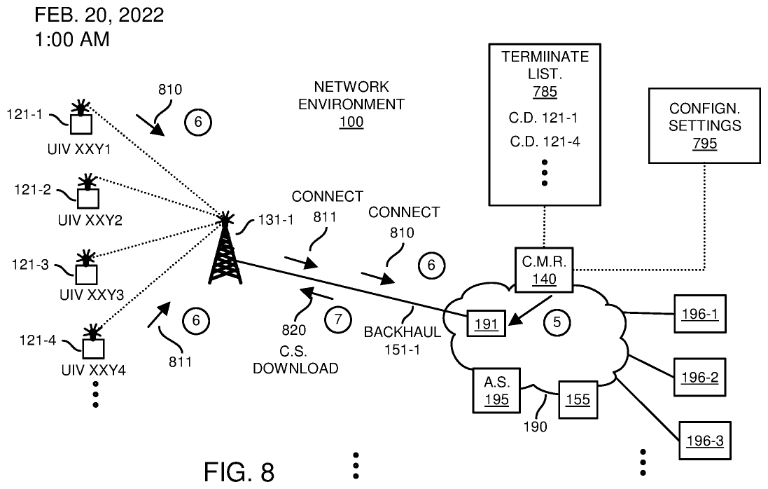

FIG. 8 is an example diagram illustrating broadcast of configuration settings at a scheduled time to terminate operation of one or more vacation devices according to embodiments herein.

In operation #5, the communication management resource 140 or other suitable entity communicates the configuration settings 795 to the network server 191 or gateway 131-1.

Each of the wireless communication devices 121-1 and 121-2 monitors the current time and day and establishes, in operation #6, wireless connectivity with gateway 131-1 or other gateway at 1:00 am on Feb. 20, 2022 (i.e., the time scheduled for the broadcast of the configuration settings 795).

In one embodiment, at the scheduled time, each of the wireless communication devices 121-1 and 121-4 connect to the network server 191 at 1:00 am via transmission of communications to the network server 191 or other suitable entity. For example, at the appropriate scheduled time as specified by the prior communications 710 and 711 as previously discussed, the wireless communication device 121-1 transmits communications 810 to the network server 191 to join the respective multicast link provided by gateway 131-1 and/or network server 191. The wireless communication device 121-4 transmits communications 811 to the network server 191 to join the respective multicast link.

In operation #7, the network server 191 or other suitable entity communicates the configuration settings 795 over backhaul 151-1 to the gateway 131-1. Gateway 131-1, in turn, broadcasts an encrypted version of the configuration settings 795 to the wireless communication devices over the multicast link. Each of the wireless communication devices 121-1 and 121-4 decrypts the configuration settings 795, applies the configuration settings 795 to the respective wireless communication device. Implementation of the configuration settings 795 by each of the wireless communication devices 121-1 and 121-4 results in decommissioning each of the devices so that they no longer attempt to wirelessly connect to any gateways in the network environment 100.

Accordingly, embodiments herein include, via the communication management resource 140, transmitting reconfiguration information (configuration settings 795) to the wireless communication devices 121-1, 121-4, etc., on the termination list 785. Execution of the reconfiguration information (configuration settings 795) by each of the wireless communication devices 121-1 and 121-4 prevents the respective wireless communication device from communicating with the wireless network again using the previously available wireless access services.

Thus, the communication management resource 140 can be configured to create a multicast group with a list of device identifiers (such as XXY1, XXY4, etc.) indicating wireless communication devices to be made non-operational. The communication management resource 140 communicates an invalid device image such as vis FUOTA to render the respective wireless communication device 121-1, 121-4, etc., non-operational. The communication management resource 140 such as including a firmware update server creates image/firmware (such as configuration settings 795) to be sent to the wireless communication devices on the termination list 785. The wireless communication devices negotiate with the network server 191 at the distribution window (scheduled time) starting at 1 p.m. on Feb. 20, 2022, to receive the configuration settings 795 The wireless communication devices may negotiate, fragmentation size, redundancy, etc. The network server 195 communicates the configuration settings such as firmware updates to the wireless communication devices. Each of the wireless communication devices authenticates the sender to ensure that the configurations settings are valid. Each of the wireless communication devices 121-1 and 121-4 installs the received image (configuration settings) and reboots itself. Execution of the configuration settings 795 (such as one or more of new image, software patch, etc.) renders the device un-operational.

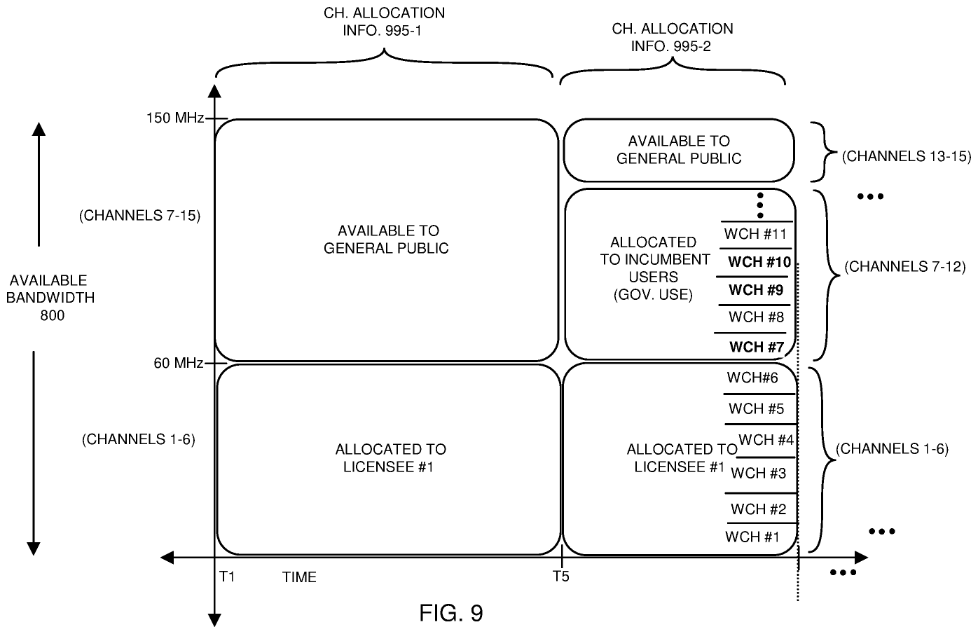

FIG. 9 is an example diagram illustrating dynamic channel allocation information indicating allocation of bandwidth at different tiers of a channel hierarchy according to embodiments herein.

As previously discussed, wireless access manager 155 can be configured to allocate any suitable type of wireless spectrum (bandwidth, wireless channels, shared wireless channels, etc.) for use by the entities associated with network environment 100.

In one non-limiting example embodiment, the wireless access manager 155 allocates bandwidth (to support the wireless connectivity as discussed herein) from a so-called CBRS (Citizens Band Radio System) band (shared spectrum) operating between 3.550 and 3.700 GHz (GigaHertz) (such as 150 MegaHertz or 15 wireless channels that are each 10 MHz wide).

The wireless access manager 155 can be configured to (such as spectrum access system, allocation management resource, or other suitable entity) keeps track, at any given time, which wireless channels or portions of the multi-tier shared wireless spectrum or multi-tier radio band (such as CBRS band) are available in the geographical region in which the network environment 100 resides. If government use (a so-called incumbent user) is detected or requested via appropriate input (such as around time T5) to an allocation management resource such as spectrum access system monitoring use of wireless channels, certain channels are no longer available for use as shown in the channel access information 195-2 as shown in FIG. 5.

More specifically, in this example, the channel availability information 195-1 (a first instance of allocation information 195) indicates that prior to time T5, channels 7-15 are available to the general authorized access users (general public or low priority users) for use; channels 1-6 are available for use by licensee #1. In a manner as previously discussed, one or more of the available channels 1-15 are allocated for use by one or more of the entities in the network environment 100 to support wireless connectivity in a manner as previously discussed.

As further shown, at or around time T5, assume that the wireless access manager 155 (or other entity such as a spectrum access system supporting allocation of wireless channels to the wireless access manager 155) receives input indicating use of a portion (channels 7-12) of the spectrum by an incumbent user such as the government. In such an instance, the allocation management resource (such as spectrum access system) updates the channel availability information such that the channel allocation information 195-2 indicates that only channels 1-7 and 13-15 are available to the licensed and general authorized access users; channels 7-12 are assigned for use by an incumbent entity requesting use or actually using the channels. Thus, after time T5, the wireless channels 7-12 are no longer available for use by the lower priority users (i.e., general authorized access users). The wireless access manager 155 revokes/discontinues use of any wireless channels that have been revoked.

In one embodiment, in response to revocation of the allocation of wireless channels 7-12, the allocation management resource notifies the one or more entities in the network environment 100 that one or more of wireless channels 7-12 are no longer available for use.

Thus, between time T1 and time T5, the entities may be allocated use of one or more allocated wireless channels. At or around time T5, the wireless access manager 155 revokes/deallocates use of the previously allocated one or more wireless channels.

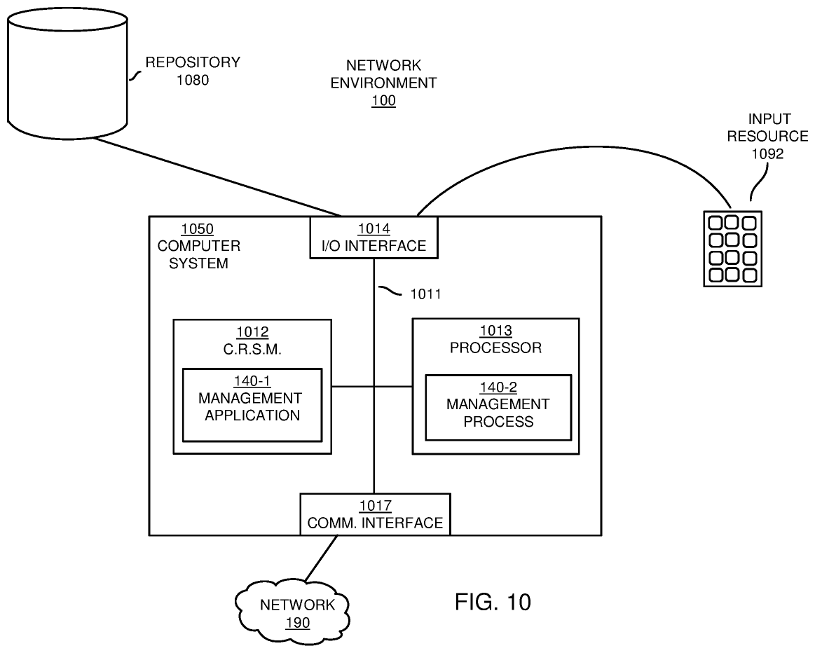

FIG. 10 is an example block diagram of a computer system for implementing any of the operations as previously discussed according to embodiments herein.

Note that any of the resources (such as communication management resource 140, network server 191, gateway 131, wireless communication devices, join server 185, authentication server 195, etc.) as discussed herein can be configured to include computer processor hardware and/or corresponding executable instructions to carry out the different operations as discussed herein.

For example, as shown, computer system 1050 of the present example includes interconnect 1011 coupling computer readable storage media 1012 such as a non-transitory type of media (which can be any suitable type of hardware storage medium in which digital information can be stored and or retrieved), a processor 1013 (computer processor hardware), I/O interface 1014, and a communications interface 1017.

I/O interface(s) 1014 supports connectivity to repository 1080 and input resource 1092.

Computer readable storage medium 1012 can be any hardware storage device such as memory, optical storage, hard drive, floppy disk, etc. In one embodiment, the computer readable storage medium 1012 stores instructions and/or data.

As shown, computer readable storage media 1012 can be encoded with management application 140-1 (e.g., including instructions associated with any entity as discussed herein) in a respective wireless station to carry out any of the operations as discussed herein.

During operation of one embodiment, processor 1013 accesses computer readable storage media 1012 via the use of interconnect 1011 in order to launch, run, execute, interpret or otherwise perform the instructions in management application 140-1 stored on computer readable storage medium 1012. Execution of the management application 140-1 produces management process 140-2 to carry out any of the operations and/or processes as discussed herein.

Those skilled in the art will understand that the computer system 1050 can include other processes and/or software and hardware components, such as an operating system that controls allocation and use of hardware resources to execute the management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1050 may reside at any location or can be included in any suitable resource in any network environment to implement functionality as discussed herein.

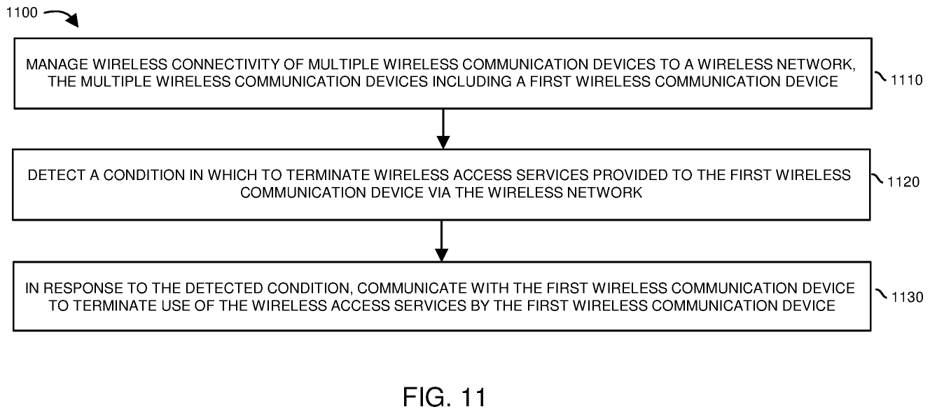

Functionality supported by the different resources will now be discussed via flowcharts in FIG. 11. Note that the steps in the flowcharts below can be executed in any suitable order.

FIG. 11 is a flowchart 1100 illustrating an example method according to embodiments herein. Note that there will be some overlap with respect to concepts as discussed above.

In processing operation 1110, the communication management resource 140 manages wireless connectivity of multiple wireless communication devices to a wireless network, the multiple wireless communication devices including a first wireless communication device.

In processing operation 1120, the communication management resource 140 detects a condition in which to terminate wireless access services provided to the first wireless communication device via the wireless network.

In processing operation 1130, in response to the detected condition, the communication management resource 140 communicates with the first wireless communication device to terminate use of the wireless access services by the first wireless communication device.

Note again that techniques herein are well suited to facilitate processing of available physical infrastructure information and generation of a proposed wireless network installation plan for implementation of the new wireless network. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
managing wireless connectivity of multiple wireless communication devices to a wireless network, the multiple wireless communication devices including a first wireless communication device;
detecting a condition in which to terminate wireless access services provided to the first wireless communication device via the wireless network; and
in response to the detected condition, communicating with the first wireless communication device to terminate use of the wireless access services by the first wireless communication device.

2. The method as in claim 1, wherein detecting the condition in which to terminate wireless access services includes:
receiving notification of a request by the first wireless communication device to establish a wireless communication link with the wireless network; and
mapping an identity of the first wireless communication device to termination information specifying to terminate use of the wireless access services by the first wireless communication device.

3. The method as in claim 2, wherein communicating with the first wireless communication device to terminate the wireless access services includes:
communicating a command to the first wireless communication device, execution of the command by the first wireless communication device preventing the first wireless communication device from attempting to wirelessly communicate with the wireless network again.

4. The method as in claim 1, wherein communicating with the first wireless communication device to terminate the wireless access services includes:
communicating a join accept message to the first wireless communication device, the join accept message granting a wireless connection of the first wireless communication device to the wireless network.

5. The method as in claim 4, wherein the join accept message includes a command notifying the first wireless communication device that the wireless access services have been revoked, execution of the command by the first wireless communication device preventing subsequent connectivity of the first wireless communication device with the wireless network.

6. The method as in claim 1, wherein communicating with the wireless communication device includes:
transmitting a communication to the first wireless communication device, the communication including a command to operate the first wireless communication device in a mode of depleting an energy source powering the first wireless communication device.

7. The method as in claim 6, wherein the command indicates to operate the first wireless communication device in a transmitter mode of transmitting wireless signals at a specified time to deplete the energy source.

8. The method as in claim 1, wherein communicating with the first wireless communication device to terminate the wireless access services includes:
transmitting a command notifying the first wireless communication device to deplete an energy source powering the first wireless communication device via transmission of wireless signals from the first wireless communication device.

9. The method as in claim 8, wherein the command specifies settings in which to transmit the wireless signals from the first wireless communication device.

10. The method as in claim 1, wherein communicating with the wireless communication device to terminate the wireless access services includes:
in response to receiving a request to use the wireless access services, communicating a denial of service notification to the first wireless communication device, the denial of service notification denying use of the wireless access services to the first wireless communication device.

11. The method as in claim 1, wherein communicating with the wireless communication device to terminate the wireless access services includes:
transmitting reconfiguration information to the first wireless communication device, the reconfiguration information preventing the wireless communication device from communicating with the wireless network using the wireless access services.

12. The method as in claim 11, wherein communicating with the wireless communication device to terminate the wireless access services includes:
notifying the wireless communication device of a scheduled time in which to receive the reconfiguration information; and
broadcasting the reconfiguration information to the first wireless communication device at the scheduled time.

13. The method as in claim 1, wherein communicating with the first wireless communication device to terminate use of the wireless access services by the first wireless communication device includes:
communicating a command to the first wireless communication device, execution of the command by the first wireless communication device causing the first wireless communication device to deactivate itself.

14. The method as in claim 1, wherein communicating with the first wireless communication device to terminate the wireless access services includes:
notifying the first wireless communication device of a scheduled time in which to receive a software patch for execution by the first wireless communication device; and
transmitting the software patch to the first wireless communication device at the scheduled time, execution of the software patch by the first wireless communication device preventing the first wireless communication device from communicating with the wireless network using the wireless access services.

15. A system comprising:
communication management hardware operative to:
manage wireless connectivity of multiple wireless communication devices to a wireless network, the multiple wireless communication devices including a first wireless communication device;
detect a condition in which to terminate wireless access services provided to the first wireless communication device via the wireless network; and
in response to the detected condition, communicate with the first wireless communication device to terminate use of the wireless access services by the first wireless communication device.

16. The system as in claim 15, wherein the communication management hardware is further operative to:
receive notification of a request by the first wireless communication device to establish a wireless communication link with the wireless network; and
map an identity of the first wireless communication device to termination information specifying to terminate the wireless access services.

17. The system as in claim 16, wherein the communication management hardware is further operative to:
communicate a command to the first wireless communication device, execution of the command by the first wireless communication device preventing the first wireless communication device from attempting to wirelessly communicate with the wireless network again.

18. The system as in claim 15, wherein the communication management hardware is further operative to:
communicate a join accept message to the first wireless communication device, the join accept message granting a wireless connection of the first wireless communication device to the wireless network.

19. The system as in claim 18, wherein the join accept message includes a command notifying the first wireless communication device that the wireless access services have been revoked, execution of the command by the first wireless communication device preventing subsequent connectivity of the first wireless communication device with the wireless network.

20. The system as in claim 15, wherein the communication management hardware is further operative to:
transmit a communication to the first wireless communication device, the communication including a command to operate the first wireless communication device in a mode of depleting an energy source powering the first wireless communication device.

21. The system as in claim 20, wherein the command indicates to operate the first wireless communication device in a transmitter mode of transmitting wireless signals at a specified time to deplete the energy source.

22. The system as in claim 15, wherein the communication management hardware is further operative to:
transmit a command notifying the first wireless communication device to deplete an energy source powering the first wireless communication device via transmission of wireless signals from the first wireless communication device.

23. The system as in claim 22, wherein the command specifies settings in which to transmit the wireless signals from the first wireless communication device.

24. The system as in claim 15, wherein the communication management hardware is further operative to:
in response to receiving a request to use the wireless access services, communicate a denial of service notification to the first wireless communication device, the denial of service notification denying use of the wireless access services by the first wireless communication device.

25. The system as in claim 15, wherein the communication management hardware is further operative to:
transmit reconfiguration information to the first wireless communication device, the reconfiguration information preventing the wireless communication device from communicating with the wireless network using the wireless access services.

26. The system as in claim 25, wherein the communication management hardware is further operative to:
notify the wireless communication device of a scheduled time in which to receive the reconfiguration information; and
broadcast the reconfiguration information to the first wireless communication device at the scheduled time.

27. The system as in claim 15, wherein the communication management hardware is further operative to:
communicate a command to the communication device, the command causing the communication device to deactivate itself.

28. The system as in claim 15, wherein the communication management hardware is further operative to:
notify the first wireless communication device of a scheduled time in which to receive a software patch for execution by the first wireless communication device; and
transmit the software patch to the first wireless communication device at the scheduled time, execution of the software patch by the first wireless communication device preventing the first wireless communication device from communicating with the wireless network using the wireless access services.

29. Computer-readable storage hardware having instructions stored thereon, the instructions, when carried out by computer processor hardware, cause the computer processor hardware to:
manage wireless connectivity of multiple wireless communication devices to a wireless network, the multiple wireless communication devices including a first wireless communication device;
detect a condition in which to terminate wireless access services provided to the first wireless communication device via the wireless network; and
in response to the detected condition, communicate with the first wireless communication device to terminate use of the wireless access services by the first wireless communication device.
